(19) United States
(12) Patent Application Publication
(10) Pub. No.: US 2017/0227767 A1
(43) Pub. Date: Aug. 10, 2017

(54) ELECTRIC SHUTTER TYPE HEAD-UP DISPLAY DEVICE

(71) Applicant: E-LEAD ELECTRONIC CO., LTD., Changhua (TW)

(72) Inventor: Stephen CHEN, CHANGHUA (TW)

(21) Appl. No.: 15/016,981

(22) Filed: Feb. 5, 2016

(51) Int. Cl. G02B 27/01

(52) U.S. Cl. CPC G02B 27/0149

(57) ABSTRACT

The present invention relates to an electric shutter type head-up display device, including a base, a display module, a reflective mirror, a reflective module, a gear set, a groove and a shutter, wherein a reflective sheet is set on the reflective module, the reflective module is provided to fasten a flip angle of the reflective sheet and a shutter controlled on the dashboard is used to open and close for storage and protection of the to head-up display device.

### BACKGROUND OF THE INVENTION

a) Field of the Invention The present invention relates to an electric shutter type head-up display device and, more particularly, to an electric shutter type head-up display device with an shutter for opening and closing, a reflective module is provided to fasten a flip angle of the reflective sheet and a shutter controlled on the dashboard is used to open and close for storage and protection of the to head-up display device.

b) Description of Prior Art

Head-up display is originated in aviation technology, and it is mainly convenient for pilots to obtain necessary information. Information may be directly projected on a front end of a cockpit to prevent pilots from bowing is heads to check the information on dashboard. The displayed information of head-up display may be easily combined with the scene outside. Since the image information reflected into pilots' eyes may be balanced with the central axis of the aircraft, the height of pilots may not cause deviation on pitch angle or visual sight. It could be known that design intent of head-up displays is to let pilots always head up without bowing their head to check information displayed on dashboard, to reduce ignoring rapid changes in external environment between bowing and heading up, and avoid delay and discomfort generated by constantly adjusting focal length of eyes.

One of the biggest reasons of car accidents happened is that driver's eyes off the road ahead during driving. In order to reduce the frequency and duration of driver's eyes off the road ahead, some vehicle manufacturers may equip head-up displays on luxury cars, and drivers may know information, such as car speed and engine speed, without leaving their eye from front windshields for keeping traffic safety.

Under normal driving condition, the shortest time for drivers leaving their eyes from the front to read the information on dashboard is 0.5 second. For the speed of 100 km/hr on highway and the driving distance of 30 meters per second, risk increases under the condition of many vehicles on the road. For safety, manufacturers equip head up displays in some cars to reduce driver distraction, and head up displays are equipped as a marketing gimmick to attract consumers.

The technology of head-up displays used in cars recently is not as complicated as head-up displays used in aircrafts. It is one kind of optical system, which is generally consisted of two main units, a projector and a to combiner. The projector is consisted of signal light source, projection lens and other optical elements. The signal light source of the projector is constituted of equipments such as LCD monitors or cathode ray tubes. Light is emitted from the signal light source and projected to the combiner on glass (or a specially made transparent screen) through the projector, and the combiner is shows words or images.

In recent years, a plenty of external head-up displays for additional installation in vehicles are appeared in the market. The function of these head-up displays includes the ordinary functions of showing car speed, engine speed, and the functions of showing water temperature, throttle position, fuel, speeding warning, parking information on the screen and battery voltage, and even integrating with a speed measuring radar. Some products are emphasized as quick installation that they may only be connected to car PC without wiring. In luxury cars of some car manufacturers, Information of navigation system and front and rear vehicle distance are added into the displayed information of head-up displays, and it increases convenience for drivers. The price of external head-up displays in the market is from several hundred dollars for simple functions to more than ten thousand dollars for excellent quality and multiple functions.

In recent years, application technology of a head-up display device is very common, but it is usually set on a vehicle dashboard in a bare way, so it is easy to have dust on it and the reflection effect of a reflection sheet may be affected. In order to prevent dust and protect the head-up display device, various head-up display devices with a flipping or hiding function have been developed in industry, related technologies may be referred to the cited references CN 201410091114.1, CN 201410513879.X, CN 200780049317.2, CN 201320821555.3, CN 201310086368.X, CN 201320833672.1. Although the cited references could solve the dust and storage problems, there are drawbacks in use, for example:

1. In some of the above cited references, a back side of a reflective to sheet is used as a cover for covering. In this way, there is a drawback that the strength of the reflective sheet is limited, the original reflection effect of the reflective sheet may be affected if an external impact or an external force is applied.

2. In most of the above cited references, an opening is set on a top side is of a base for the expanded or folded reflection sheet to pass through, so a cover plate is needed for covering on the opening. However, a flip space for opening and closing the cover plate is needed, so a necessary space is large and the volume could not be reduced, available space on the vehicle dashboard may be eliminated.

### SUMMARY OF THE INVENTION

In view of the drawbacks of the conventional ones, the inventor finally completed the electric shutter type head-up display device of the present invention after numerous improvements, namely, the object of the present invention is to provide an electric shutter type head-up display device with an shutter for opening and closing, a reflective module is provided to fasten a flip angle of the reflective sheet and a shutter controlled on the dashboard is used to open and close for storage and protection of the head-up display device.

To achieve the object, the electric shutter type head-up display device of the present invention, including:

a base, a capacity space and an opening are set inside, and a circuit board is set on the base;

a display module, which is electrically connected to the circuit board, the display module set in a front end of the capacity space is provided to project a received image output from the circuit board;

a reflective mirror, which is set in a rear end of the capacity space, the reflective mirror is provided to reflect the image projected from the display module;

a reflective module, which includes a reflective sheet and a shaft group, the reflective module is placed in the front end of the capacity space;

a gear set, which is set in the capacity space;

a groove, which is set on an inner side wall of the base;

a shutter, which is embedded into the groove and the gear set.

The reflective sheet, which is a concave mirror with translucent and semi-reflecting effect, the reflective sheet is provided to enlarge a virtual is image due to concave mirror image performance and reflect the enlarged image projected by the display module.

The base is embedded in a vehicle dashboard.

The reflective module, which is an electric reflective module, the reflective module includes a first motor, the first motor is electrically connected to the circuit board, the first motor is engaged with the shaft group.

The shaft group, which includes a shaft and an elastic element, the elastic element is slipped on the shaft.

The gear set, which is set in the rear end of the capacity space, the gear set includes a second motor and a chain ring, the chain ring includes multiple teeth, and the second motor is electrically connected to the circuit board.

The groove is a U-shaped concave track.

The shutter, multiple notches and multiple bosses are set on it, the bosses are embedded into the groove, and the notches of the shutter are engaged with the gear set.

The electric shutter type head-up display device further includes a button group, the button group is electrically connected to the circuit board, the button group is provided to operate functions of the electric shutter type head-up display device.

The electric shutter type head-up display device of the present invention further includes a cable, the cable is electrically connected to the circuit board, the cable is provided to connect to an electronic device for receiving signal information.

The electric shutter type head-up display device of the present to invention further includes a wireless module, the wireless module is electrically connected to the circuit board, the wireless module is provided to receive signal information from an electronic device by wired transmission.

The electric shutter type head-up display device of the present invention further includes an optical sensing module, the optical sensing is module is electrically connected to the circuit board, the optical sensing module is provided to adjust the brightness of the display module.

The electric shutter type head-up display device of the present invention further includes a speaker module, the speaker module is electrically connected to the circuit board, and the speaker module is provided to inform a driver of the received voice signals.

### BRIEF DESCRIPTION OF THE DRAWINGS

FIG. 1 is a three-dimensional structure diagram of the present invention;

FIG. 2 is a schematic diagram of the reflective module of the present invention;

FIG. 3 is a circuit block diagram of the embodiment of the present invention;

FIG. 4 is a schematic diagram of opening the shutter of the embodiment of the present invention;

FIG. 5 is a schematic diagram of closing the shutter of the embodiment of the present invention;

FIG. 6 is a schematic diagram of the button group of the embodiment of the present invention;

### DETAILED DESCRIPTION OF THE INVENTION

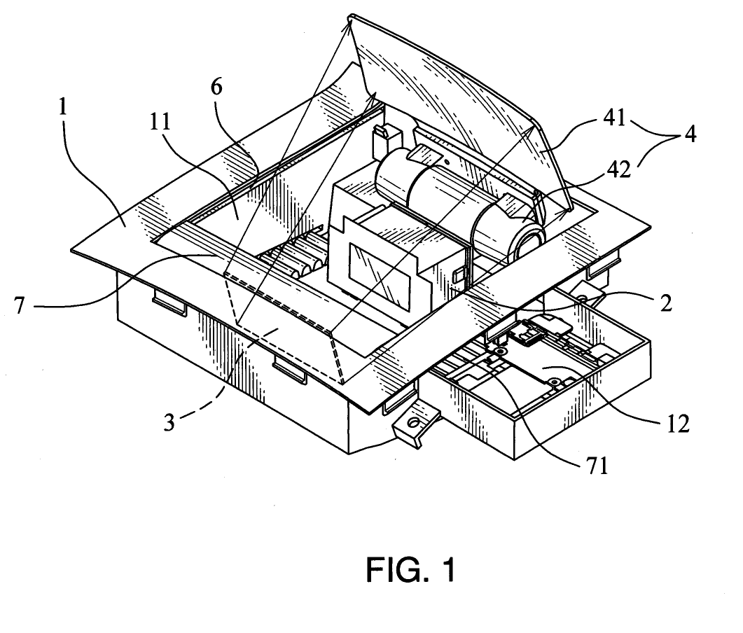

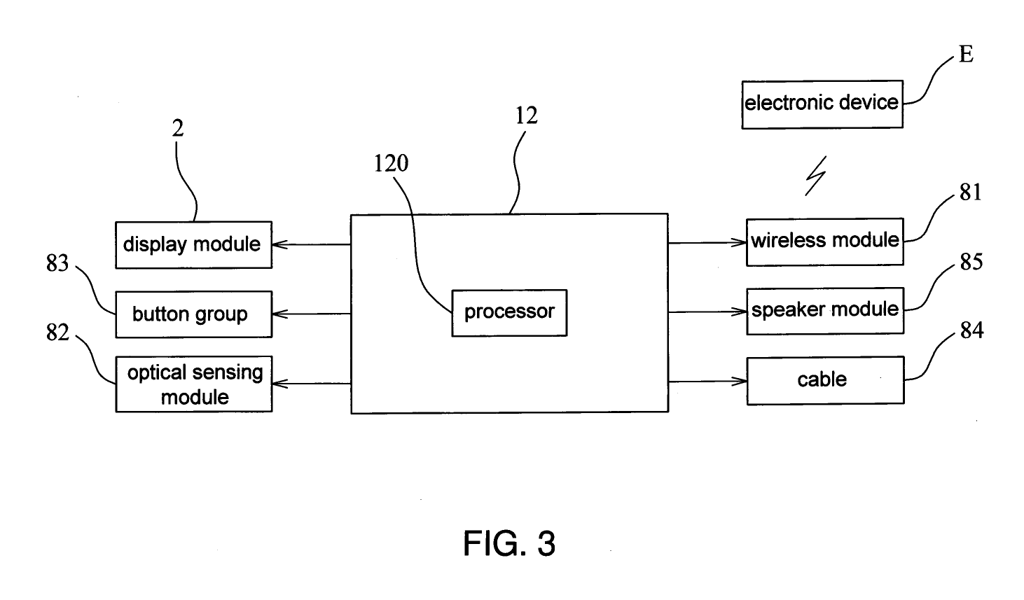

Please refer to FIG. 1 to FIG. 5, the electric shutter type head-up display device of the present invention, including:

a base 1, which is embedded in a dashboard B under a windshield W, a capacity space 11 and an opening 13 are set inside, and a circuit board 12 is set on the base; the circuit board 12 includes a processor 120, the processor 120 is provided to control data processing and process related information, and output an image information;

a display module 2, which is electrically connected to the circuit board 12, the display module 2 set in a front end of the capacity space 11 is provided to project a received image output from the circuit board 12; a reflective mirror 3, which is set in a rear end of the capacity space 11, the reflective mirror 3 is provided to reflect the image projected from the display module 2;

a reflective module 4, which includes a reflective sheet 41 and a shaft group 42, the reflective module 4 is placed in the front end of the capacity space 11;

a gear set 5, which is set in the capacity space 11, the gear set 5 includes a second motor 51 and a chain ring 52, the chain ring 52 includes multiple teeth 53, the second motor 51 is electrically connected to the circuit board 12;

a groove 6, which is set on an inner side wall of the base 1, the groove 6 is a U-shaped concave track;

a shutter 7, multiple notches 71 and multiple bosses 72 are set on it, the bosses 72 of the shutter 7 are embedded into the groove 6, the notches 71 of the shutter 7 are engaged with the teeth 53 of the chain ring 52; the chain ring 52 is driven by the rotating second motor 51, the notches 71 is driven by the teeth 53 of the chain ring 52, then the shutter 7 may be opened or closed according to motion of the second motor 51.

The reflective sheet 41 is a concave mirror with translucent and semi-reflecting effect, the reflective sheet 41 is set under the windshield W, the reflective sheet 41may enlarge a virtual image due to concave mirror image performance, may also let the distance of the virtual image become far at the same ratio, and reflect the enlarged image projected by the display module 2 to overlap with a perspective image of road ahead.

The shaft group 42, which includes a shaft 421 and an elastic element 422, the elastic element 422 is slipped on the shaft 421.

The reflective module 4 is a electric reflective module, the reflective module 4 includes a first motor 43, the first motor 43 is electrically connected to the circuit board 12, the first motor 43 is engaged with the shaft 421 of the shaft group 42. When the first motor 43 rotates, the reflective sheet 41 is is driven by the shaft 421 for adjusting the flip angle, the reflective sheet 41 is opened from the opening 13.

The electric shutter type head-up display device of the present invention further includes a wireless module 81. The wireless module 81 is provided to receive signal information from an electronic device E by wired transmission. The wireless module 81 is a Bluetooth or a Wi-Fi. The electronic device E is a vehicle equipment, a vehicle host, a vehicle audio device, a ceiling multimedia player, a headrest multimedia player, a hands free device, a navigation device, a tire pressure detection device, a smart phone or a tablet computer, etc.. Vehicle speed may be displayed if the wireless module 81 is wireless connected to the electronic device E of the vehicle. Displayed image information of the electronic device may be vehicle battery power, vehicle door is closed or not, trunk lip is closed or not, vehicle speed, road speed limits, navigation direction, vehicle tire pressure if it is a tire pressure detection device. If it is connected to a smart phone, except vehicle speed, various information send by a mobile app may be displayed, such as wireless transmission from mobile music player to the short-range wireless module 81.

The electric shutter type head-up display device of the present invention further includes an optical sensing module 82, the optical sensing module 82 is electrically connected to the circuit board 12, the optical sensing module 82 is provided to adjust the brightness of the display module 2, and the brightness of the display module 2 may be adjusted according to detected sunlight intensity, so that the driver may clearly watch the information on displayed image.

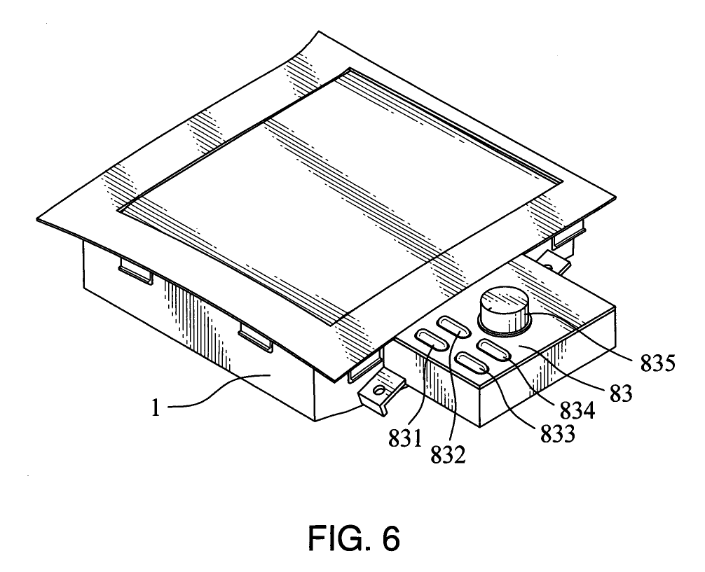

As shown in FIG. 6, the electric shutter type head-up display device of the present invention further includes a button group 83, the button group 83 is set on the base 1 or the vehicle dashboard B, the button group 83 is electrically connected to the circuit board 12, the button group 83 is provided to operate functions of the electric shutter type head-up display device; the is button group 83 includes an open button 831, a close button 832, an operation switching button 833, a stop button 834 and a knob 835; the open button 831 may be used to open the shutter 7 or the reflective sheet 41; the close button 832 may be used to close the shutter 7; the operation switching button 833 may be used to switch to operate the shutter 7 or the reflective sheet 41; the stop button 834 may be used to stop motion of the shutter 7 or the reflective sheet 41; the knob 835 may be used to manually adjust the brightness of the display module 2, turning right may increase the brightness to let the displayed image brighter, turning left may decrease the brightness to let the displayed image darker, so that the driver may be clearly watch the information on displayed image.

The electric shutter type head-up display device further includes a cable 84, the cable 84 is electrically connected to the circuit board 12, the cable is provided to connect to the electronic device E for receiving signal information. The electronic device E is a vehicle equipment, a vehicle host, a vehicle audio device, a ceiling multimedia player, a headrest multimedia player, a hands free device, a navigation device, a smart phone or a tablet computer, etc..

The electric shutter type head-up display device of the present invention further includes a speaker module 85, the speaker module 85 is electrically connected to the circuit board 12, and the speaker module 85 is provided to inform a driver of the received voice signals, a voice file sent from the electronic device E may be played or used as a warning sound.

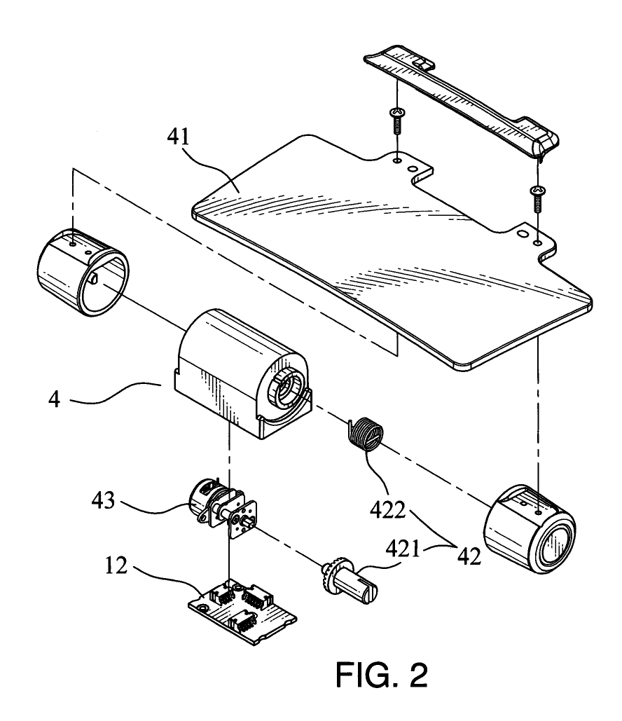

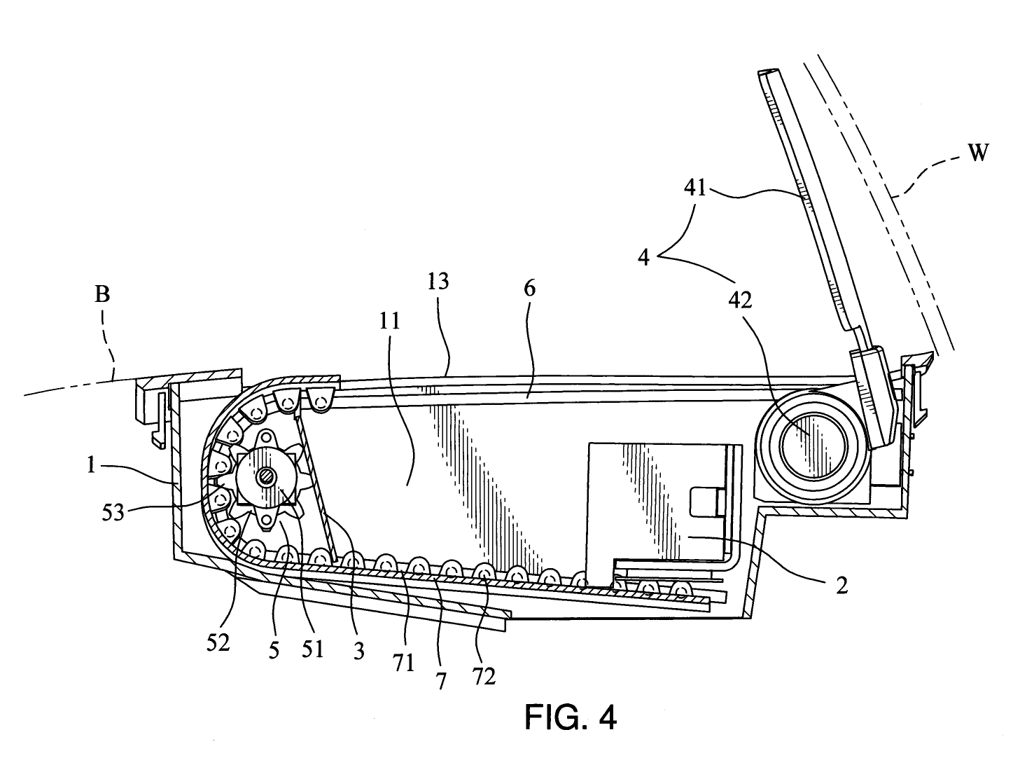

Please refer to FIG. 1, FIG. 2, FIG. 4, FIG. 6, when starting to use the electric shutter type head-up display device of the present invention, the to driver presses the open button 831 first, the second motor 51 starts to rotate and the chain ring 52 is driven to rotate, the notches 71 are driven by the teeth 53 of the chain ring 52, so that the shutter 7 may move according to the motion of the second motor 51, and the opening 13 is no more covered by the shutter 7 finally. And then, the first motor 43 of the reflective module 4 starts to is rotate, the reflective sheet 41 opens outwards and upwards from the opening 13, the reflective sheet 41 is driven by the shaft 421 for adjusting the flip angle, the first motor 43 stops until the reflective sheet 41 is flipped to a predetermined open position.

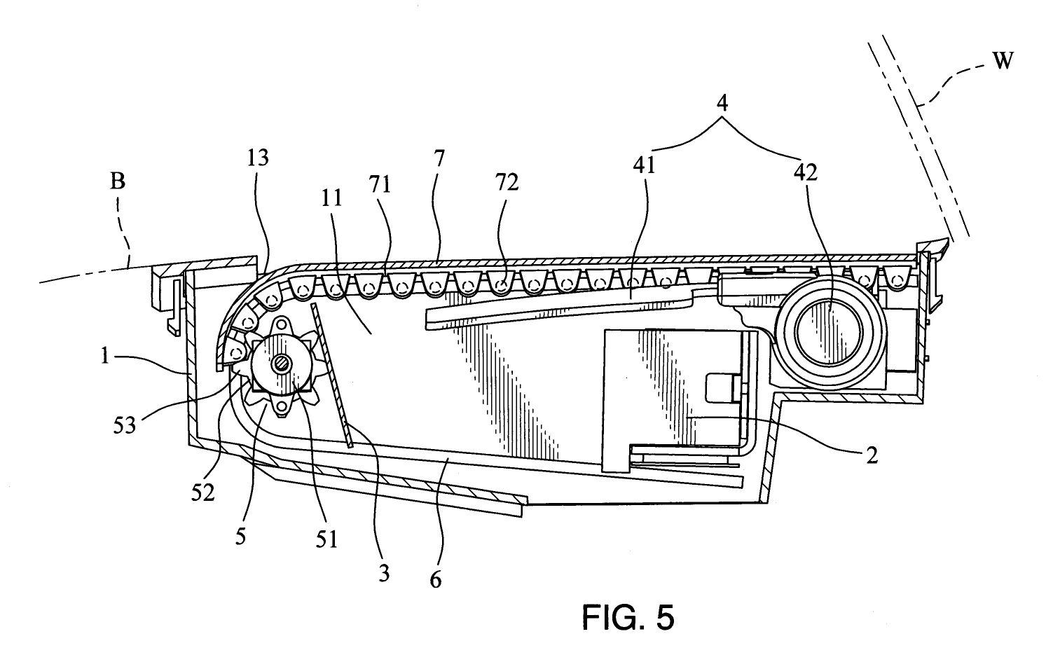

Please refer to FIG. 2, FIG. 5, FIG. 6, when wanting to stop using the electric shutter type head-up display device of the present invention, the driver presses the close button 832 first, the first motor 43 of the reflective module 4 starts to rotate reversely, the reflective sheet 41 is driven towards the opening 13 by the shaft 421 until the reflective sheet 41 is flipped to a predetermined close position, and then the second motor 51 rotates reversely and the chain ring 52 is driven, the notches 71 are driven by the teeth 53 of the chain ring 52, so that the shutter 7 closes the opening 13 according to motion of the second motor 51, and the second motor 51 stops when the opening 13 is completely covered by the shutter 7.

What is claimed is:

1. An electric shutter type head-up display device, including:
a base, a capacity space and an opening are set inside, and a circuit board is set on the base;
a display module, which is electrically connected to the circuit board, the display module set in a front end of the capacity space is provided to project a received image output from the circuit board;
a reflective mirror, which is set in a rear end of the capacity space, the reflective mirror is provided to reflect the image projected from the display to module;
a reflective module, which includes a reflective sheet and a shaft group, the reflective module is placed in the front end of the capacity space;
a gear set, which is set in the capacity space;
a groove, which is set on an inner side wall of the base;
a shutter, which is embedded into the groove and the gear set.

2. The electric shutter type head-up display device as claimed in claim 1, wherein the reflective sheet is a concave mirror with translucent and semi-reflecting effect, the reflective sheet is provided to enlarge a virtual image due to concave mirror image performance and reflect the enlarged image projected by the display module.

3. The electric shutter type head-up display device as claimed in claim 1, wherein the base is embedded in a vehicle dashboard.

4. The electric shutter type head-up display device as claimed in claim 1, wherein the reflective module is a electric reflective module, the reflective module includes a first motor, the first motor is electrically connected to the circuit board, the first motor is engaged with the shaft group.

5. The electric shutter type head-up display device as claimed in claim 1, wherein the shaft group includes a shaft and an elastic element, the elastic element is slipped on the shaft.

6. The electric shutter type head-up display device as claimed in claim 1, wherein the gear set is set in the rear end of the capacity space, the gear set includes a second motor and a chain ring, the chain ring includes multiple teeth, the second motor is electrically connected to the circuit board.

7. The electric shutter type head-up display device as claimed in claim 1, wherein the groove is a U-shaped concave track.

8. The electric shutter type head-up display device as claimed in claim 1, wherein multiple notches and multiple bosses are set on the shutter, the bosses are embedded into the groove, the notches of the shutter are engaged with the gear set.

9. The electric shutter type head-up display device as claimed in claim 1, further includes a button group, the button group is electrically connected to the circuit board, the button group is provided to operate functions of the electric shutter type head-up display device.

10. The electric shutter type head-up display device as claimed in is claim 1, further includes a cable, the cable is electrically connected to the circuit board, and the cable is provided to connect to an electronic device for receiving signal information by wired transmission.

11. The electric shutter type head-up display device as claimed in claim 1, further includes a wireless module, the wireless module is electrically connected to the circuit board, and the wireless module is provided to receive signal information from an electronic device by wired transmission.

12. The electric shutter type head-up display device as claimed in claim 1, further includes an optical sensing module, the optical sensing module is electrically connected to the circuit board, and the optical sensing module is provided to adjust the brightness of the display module.

13. The electric shutter type head-up display device as claimed in claim 1, further includes a speaker module, the speaker module is electrically connected to the circuit board, and the speaker module is provided to inform a driver of the received voice signals.
